(19) United States
(12) Patent Application Publication
(10) Pub. No.: US 2011/0027110 A1
(43) Pub. Date: Feb. 3, 2011

(54) OIL FILTER FOR DOWNHOLE MOTOR

(75) Inventors: Stanislav Nikolaevich Verichev, Nizhny Novgorod (RU); Jacques Orban, Moscow (RU); Evgeny Mikhailovich Sviridov, Moscow (RU)

Correspondence Address: SCHLUMBERGER RESERVOIR COMPLETIONS, 14910 AIRLINE ROAD, Bldg. 14, ROSHARON, TX, 77583, US

(73) Assignee: SCHLUMBERGER TECHNOLOGY CORPORATION

(21) Appl. No.: 12/864,683

(22) PCT Filed: Jan. 31, 2008
(86) PCT No.: PCT/RU08/00052

§ 371 Date: Sep. 20, 2010

(51) Int. Cl. F04B 17/03; B01D 35/02; B01D 29/50; B01D 15/00; H02K 5/132

(52) U.S. Cl. 417/410.1; 210/259; 210/256; 310/87

(57) ABSTRACT

A method of controlling operation of an ESP, comprising determining at least one operating speed (rpm) at which the ESP experiences unacceptable levels of lateral vibrations; and applying a periodic modulation to the operating speed when operating the pump at the determined speed to damp the lateral vibrations.

### TECHNICAL FIELD

This invention relates to techniques for damping lateral vibrations in electric submersible pumps (ESPs) of the type typically used in the oil industry. In particular, the invention relates to techniques for controlling motor speed to damp such vibrations.

### BACKGROUND ART

ESPs are used in the oil industry to provide artificial lift in oil wells that do not have enough pressure to produce to the surface. ESPs typically comprise a motor section and a pump section, often separated by a protector section including a crossover and pump inlet. Because of the typical dimensions of an oil well, it is necessary for the motor (and pump) to be formed as a relatively long and thin unit. A shaft (or combination of shafts) extends through the motor so as to support a rotor inside as stator section; and then extends into the pump section where it supports a series of impellers which, together with corresponding diffusers fixed to the pump housing define a centrifugal pump. Such pumps typically operate at speeds of up to 3000 rpm, although higher speeds have been proposed.

While the pumps are designed to operate at substantially constant speed, there is a time during startup where operation will be taking place at other speeds for periods of time. It is generally attempted to balance the rotating structure of the ESP at the desired operational speed to avoid unwanted lateral vibrations.

It is known that lateral vibration of ESP shafts may reach undesirable values. This can happen, for example, during the startup and shutdown, when the ESP has to pass through a number of resonant frequencies; or during normal fluctuations of the operational speed if the ESP spectrum contains resonances close to this speed. Increases in vibrations may occur because of fluctuations of the ESP parameters during operation. Typical causes include:
The appearance of scale deposits on rotating parts leading to an increase of the pump total mass which in turn leads to the shift of spectrum of the critical frequencies towards lower frequencies (initially, operating speeds lie outside resonance zones but in the course of time it might move inside one of those). Increase of ESP imbalances is also found as the distribution of deposits is not uniform.
Wear of the bearings due to changes in the lubricant parameters, stiffness, damping ratio, viscosity variation. Bearing geometry also changes because of the wear etc..
Inhomogeneity of production fluid (appearance of gas, solids etc.).

The use of vibration dampers is not considered appropriate in case of ESPs as there is no possibility to tune the frequency band of a vibration damper since the shift of critical frequencies is generally unknown.

This invention seeks to provide an alternative method of damping based on operational control of the ESP.

### DISCLOSURE OF THE INVENTION

A first aspect of the invention provides a method of controlling operation of an ESP, comprising:
determining at least one operating speed (rpm) at which the ESP experiences unacceptable levels of lateral vibrations; and
applying a periodic modulation to the operating speed when operating the pump at the determined speed to damp the lateral vibrations.

Preferably, the periodic modulation comprises a harmonic additive of the determined operating speed, the method typically including determining values for amplitude and phase shift of the harmonic additive at which lateral vibrations are damped. The periodic modulation to be applied can be determined according to the relationship:

Ω+AnΩ cos (nΩt+ω₀)

where Ω is the frequency of rotations, A and ω₀ are the amplitude and the phase shift of the harmonic additive, t is the time, n is a number.

The periodic modulation is preferably selected so as to minimize torsional vibrations in the ESP.

The periodic modulation is typically selected so as to cause a variation of operating speed of less than 5%.

The operating speed at which the ESP experiences unacceptable levels of lateral vibrations can be determined by mathematical modelling and/or experimentation.

The method can also comprise monitoring operation of the ESP to detect unacceptable levels of lateral vibration and applying the modulation to the operating speed when such levels are detected.

A second aspect of the invention provides an ESP comprising a control system which operates according to the method of the first aspect of the invention.

Further aspects of the invention will be apparent from the following description.

### BRIEF DESCRIPTION OF THE DRAWINGS

FIG. 1 shows a plot of rpm versus time for an example in the application of the present invention;

FIG. 2 shows relative maximal radial displacement versus n;

FIG. 3 shows relative maximal radial displacement versus A;

FIG. 4 shows a plot of rpm versus time for a second example in the application of the present invention;

FIG. 5 shows a lab test installation;

FIG. 6 shows a shaft with an imbalanced disk, a shaft deflection, and a disk plane (view from above) showing coordinate plane and eccentricity;

FIG. 7 shows a Bessel function of the first kind;

FIG. 8 shows a plot of amplitude versus time in at first resonant frequency (undamped system);

FIG. 9 shows the transient process of damping in the case of n=3, A=2.4;

FIG. 10 shows damped amplitude versus time in at first resonant frequency in the case of n=3, A=2.4 ;

FIG. 11 shows thte transient process of damping in the case of n=0.6, A 32 2.4;

FIG. 12 shows damped amplitude versus time in at first resonant frequency in the case of n=0.6, A=2.4;

FIG. 13 shows a transient process of damping in the case of n=1, A=2.4;

FIG. 14 shows damped amplitude versus time in at first resonant frequency in the case of n=1,; A=2.4;

FIG. 15 shows a transient process of damping in the case of n=2, A=2.7; and

FIG. 16 shows a damped amplitude versus time in at first resonant frequency in the case of n=2, A=2.7.

### Mode(s) for Carrying Out the Invention

According to the method of the invention, as soon as ESP lateral vibration reaches a critical value, generation of additional harmonic component to the constant frequency of rotations (for example, simply using frequency generator) can provide drastic decrease of such vibration. Thus, instead of rpm with frequency Ω, ESP rpm would have the form

Ω+AnΩ cos(nΩt+ω₀)

where Ω is the frequency of rotation, A and ω₀ are the amplitude and the phase shift of the harmonic additive, t is the time, n is a number. By choosing A and n one can provide different degrees of damping. Generally n can be any number: integer, fractional or even irrational. The pair of parameters should be chosen to ensure that the harmonic additive is among the allowable ones because certain changes in rpm may lead to an increase in torsional vibrations. The parameters can be determined both using mathematical modelling and experimentally.

To determine when the damping system must be activated (and/or to deactivated), it is desirable to provide feedback from the ESP relating to vibration levels. This can be done, for example, by measuring vibrations directly or inferring them from other measured operating parameters.

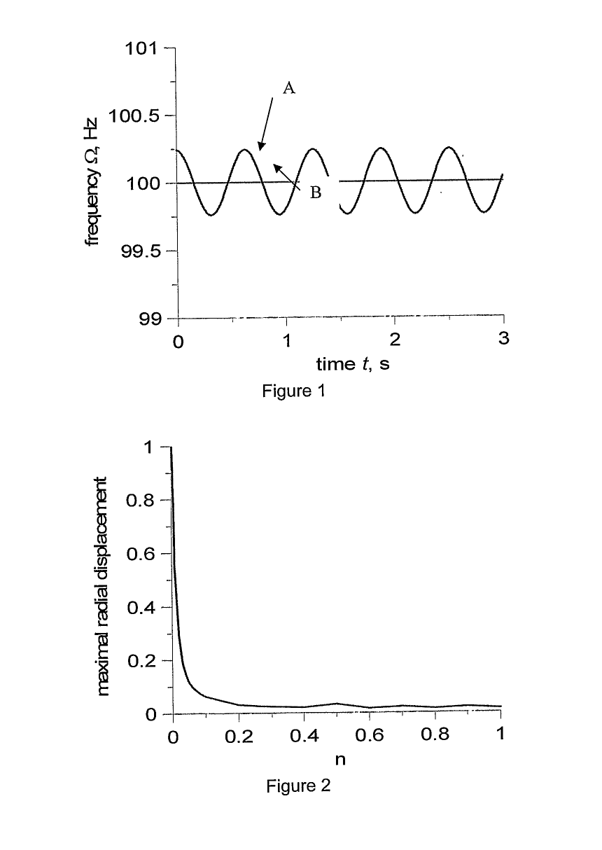

An example of the form of harmonic additive for the case Ω=100 Hz (i.e. 100 rpm), n=0.1, A=2.4, ω₀=0 (Ω+AnΩcos(nΩt+ω₀)=100+0.24 cos(10t)) is shown in FIG. 1 which displays rpm vs. time. Line A corresponds to the base operating speed/frequency (100 Hz/100 rpm) and line B corresponds to the operating speed Ω=100+0.24 cos(10t) once the periodic modulation is applied. In this case, rpm variation is about 0.5%.

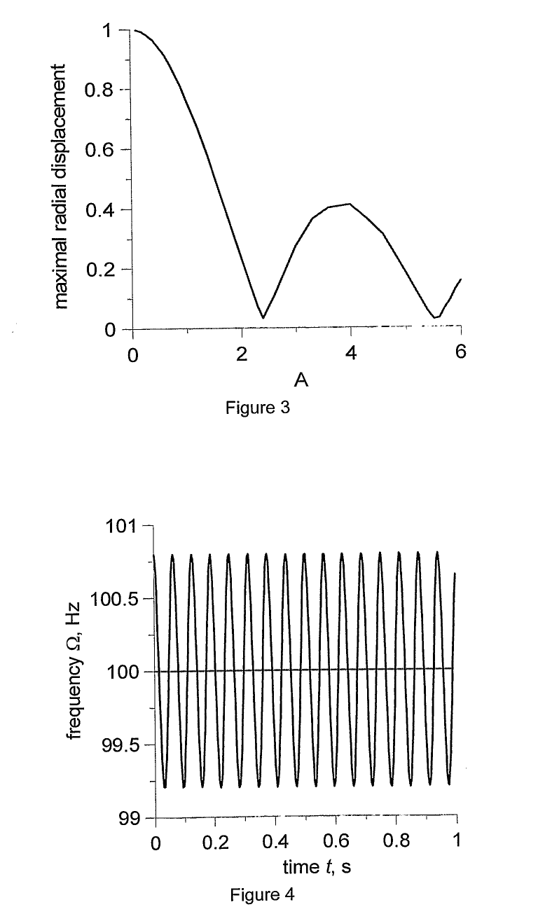

To illustrate how much vibration can be damped, normalized maximal radial displacement is shown in FIG. 2 versus n for the case A=2.4 and in FIG. 3 versus A for the case n=0.2 . In this case, rotary system is modelled as a shaft with one imbalanced disk placed in its centre (see FIG. 6). Maximal radial displacement shown in FIGS. 2 and 3 is divided by a maximal radial displacement at first natural frequency

$$ω = \sqrt{\frac{c}{m}}$$

where c is the bending stiffness of the shaft and m is the mass of the disk). Note that the shaft with one disk is quite a simple model; a more complex model might be needed to predict accurately vibrations of an ESP that has tens of masses (impellers) and a number of radial bearings quantitatively. Radial displacements for this model tend to come out much higher than those for real ESP because all masses of impellers are reduced just to the one large mass. Analytical solutions are difficult for the multi-mass model and so is not used here. However, the simplified model provides a good qualitative estimation of how much the radial vibration can be damped compared to the highest amplitudes that occur at first natural frequency

$$ω = \sqrt{\frac{c}{m}} .$$

Within a range of variation of values of A and n for the cases shown in FIGS. 2 and 3, rpm variation is 5% and less as can be seen from Table 1 below.

TABLE 1
Rpm variation versus A and n.

| | | | | |
|---|---|---|---|---|
| A | 2.4 | 2.4 | 0.1 | 6 |
| n | 0.1 | 1 | 0.2 | 0.2 |
| rpm variation | 0.5% | 5% | 0.04% | 1.5% |

By analyzing FIGS. 2 and 3, a number of conclusions can be made.

The higher the parameter n, the better the damping (see FIG. 2). Thus, it is reasonable to select n to be the highest possible. However, this number directly relates to the frequency of the harmonic additive. For example, for A=2.4, n=1 Ω=100+0.8 cos (100 t). The frequency is 10 times higher than that in the case of n=0.1 as is shown in FIG. 4. Such high frequency variation may be difficult to achieve due to ESP inertia issues. Thus, n should be chosen such that resulting frequency variation is achievable by the ESP in question. Another thing to be controlled is the level of torsional vibrations. By adding harmonic additive to damp the radial vibrations, creation of torsional vibrations should be avoided or, if present, their level should be sufficiently small as not to create problems.

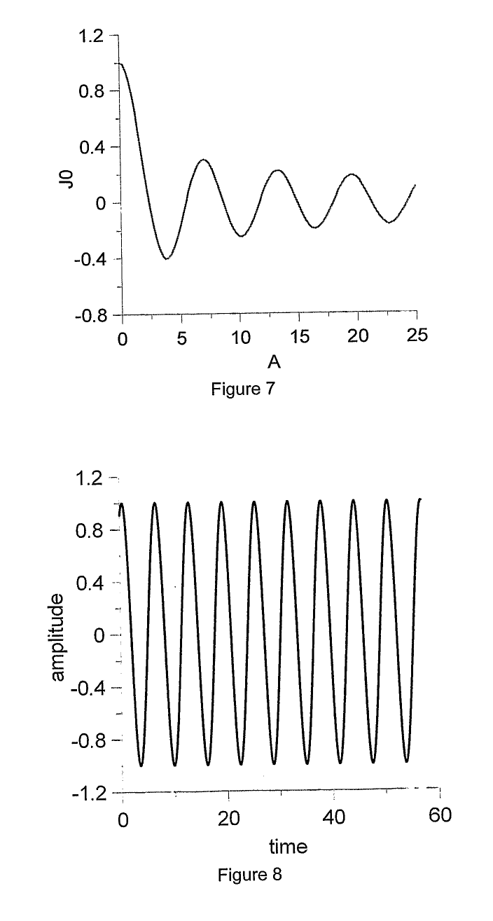

There is a number of values of A, for which damping is optimal (see two minima of the function shown in FIG. 3). This is related to the properties of Bessel functions (see FIG. 7) that enter the solution of the mathematical model. Damping is maximal, when values of A coincide with zeroes of the Bessel function. A list of zeroes of Bessel functions can be found in tables of many handbooks on mathematical functions (see for instance Abramovitz M, Stegun IA. Handbook of mathematical functions. New York: Dover; 1972) and used to find values of A. Again, the issues of torsional vibrations should be considered when choosing the amplitude of harmonic additive A.

The calculations presented above are based on a linear model in the approximation of first (“main”) resonance mode. Dynamics of real ESPs are governed by a large number of nonlinear equations accounting not only for first resonance mode but for the higher ones. An alternative to dealing with complex mathematics, is to perform a lab test aiming to:
validate effect of damping not only for the first resonance mode but also for higher harmonics;
study the effect of harmonic additives on levels of torsional vibrations;
optimize the choice of A and n;
study changes in forces acting on bearings on the shaft;
investigate how small variations of mass and imbalances affect a chosen pair of A and n (modelling of scales deposits that may lead to increase in total mass of ESP rotating parts and also increase in impellers imbalance); and
validate proposed damping procedure for different shaft inclinations (modelling of wells inclination).

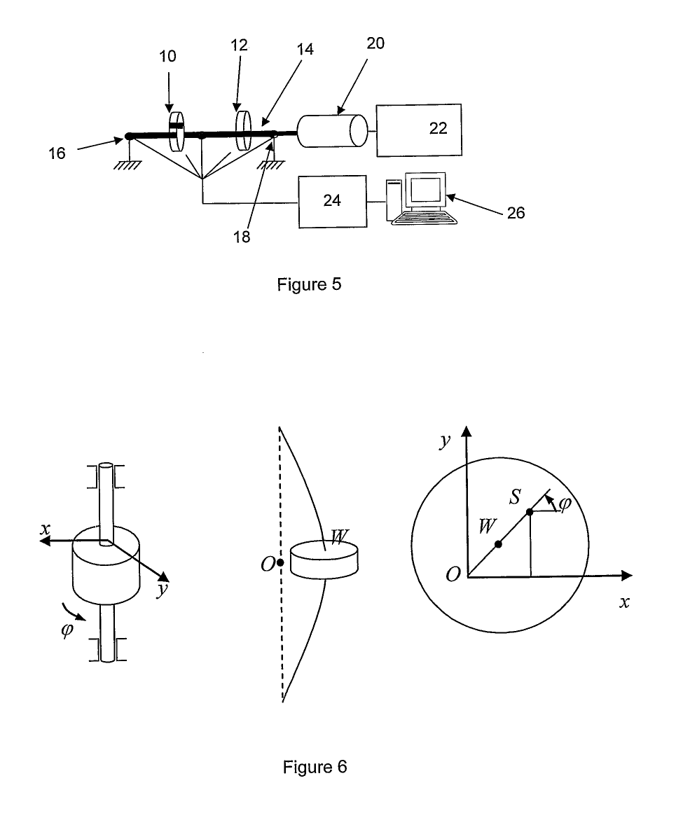

Before testing a complex structure as an ESP, it is customary to perform a lab test. FIG. 5 shows such a lab test installation comprising a number of imbalanced disks 10, 12 placed on a shaft 14 supported by bearings 16, 18 and driven by electric motor 20. The electric motor 20 is coupled to variable-frequency generator 22 that can generate the required harmonic additive to the constant or transient rpm. Several types of sensors 24 (proximity meters, accelerometers, velocity sensors and force transducers) register and transmit data (shaft offset, amplitudes of radial and torsional vibrations, forces acting on bearings) to a PC 26 for analysis.

In summary, the invention has the following features and benefits:
Two control parameters: A and n can be determined via mathematical modelling and/or experimentally;
Expected rpm variation is typically below 5%;
Harmonic additive should be minimized to ensure absence of generation of torsional vibrations;
Does not require any construction changes;
Requires vibration monitoring or estimation; and
Can be a part of an active control system.

Mathematical modelling of the ESP vibration damping in the case of non-steady rpm can be based on consideration of a dynamic system that governs bending vibrations of a rotor consisting of a shaft with one imbalanced disk driven by an infinite power supply (see Error! Reference source not found.). The disk has an eccentricity (centre of gravity is placed at certain distance apart from the disc's centre). The shaft is fixed by bearings at its ends. Point W designates the disk geometrical centre, point S designates its gravity centre and the point O designates the axis of the unperturbed shaft.

When the rotor passes through a resonance domain, a harmonic component is added to a constant torque. Such a harmonic additive may also be used in the normal operating regime in the case when a control system shows undesirable vibration increase. In both cases, constant frequency of rotation experience harmonic modulation and governing equations have the form:

$$\ddot{x} + \frac{{ɛω}_{0}}{c} \dot{x} + x + \frac{k {ω}_{0}}{c} ( \dot{x} + \dot{ϕ} y ) = e cos ϕ , \\ \ddot{y} + \frac{{ɛω}_{0}}{c} \dot{y} + y + \frac{k {ω}_{0}}{c} ( \dot{y} + \dot{ϕ} x ) = e sin ϕ , \\ \dot{ϕ} = Ω + An Ωcos ( n Ωτ + {ψ}_{0} ) .$$

Here ε and κ are the external and internal damping, respectively, c is the bending stiffness of the shaft, φ is the angle of rotation, ω₀ is the natural frequency of the rotor, Ω is the frequency of rotations, A and ω₀ are the amplitude and the phase shift of the harmonic additive, n is a number. For convenience, variables and parameters in the system above are dimensionless; Ω=ω/ω₀, differentiation is made over a dimensionless time ω₀t=τ.

Suppose that coefficients of external and internal damping, and rotor eccentricity are small:

c/m=ω₀², εω₀/c=μh, kω₀/c=μh₁, e=μv

where μ□ 1 is a small parameter. In this case, initial system takes the form

\dot{x}=x₁,

\dot{x}₁ =−Ω²x+μF₁,

\dot{y}=y₁,

\dot{y}=−Ω²y+μF₂,

\dot{ψ}=Ω.

Here F₁=ν cos φ−(h+h₁)x₁−h₁\dot{100}y+Δx, F₂=ν sin φ−(h+h₁)y₁+h₁\dot{φ}x+Δy, φ=ψ+A sin(nψ+ψ₀).

The goal is to answer the following question: would it be possible to choose the parameters of modulation A, n, ψ₀ in such way that the amplitude of bending vibrations would be minimized and how these parameters should be chosen?

A system of two non-autonomous linear oscillators is obtained. Each of these oscillators represents a resonance filter of the frequency Ω, which corresponds to the first resonance harmonic cos φ=cos(ψ+A sin(nψ+ψ₀)), sin φ=sin(ψ+A sin(nψ+ψ₀)), ψ=Ωτ.

These functions may be decomposed into the Fourier series with coefficients Jₖ (A) representing Bessel functions of the first kind of integer argument. Naturally, since the model under consideration is linear, solutions can also be represented as such series. If the first harmonic that has the highest amplitude would be damped by a proper choice of the parameters of modulation, then amplitudes of the remaining harmonics will have values of the order ˜μ<<1. This is explained by filtering properties of the oscillators. It means that maximum radial displacements xₘₐₓ, yₘₐₓ will have the same order: xₘₐₓ, yₘₐₓ ˜μ (note that x(σ), y(σ) are the mutifrequency functions). Thus, the objective is to provide damping of the first harmonic.

A direct solution of this problem is: search for the solution of the initial system as a Fourier series with undetermined coefficients; determination of these coefficients and minimization of the amplitude of the first harmonic. At the same time, stability of the solution must be ensured. Both parts are standard if quite intricate. To combine both problems into the one problem, the averaging method can be used.

Using changes of the variables of the form

x=μ₁ sin ψ+ν₁ cos ψ,

x₁=(μ₁ cos ψ−ν₁ sin ψ)Ω,

y=μ₂ sin ψ+ν₂ cos ψ,

y₁=(μ₂ cos ψ−ν₂ sin ψ)Ω,

one can obtain a system of the form:

\dot{μ}₁=μF₁ cos ψ,

\dot{ν}₁=−μF₁ sin ψ,

\dot{μ}₂=μF₂ cos ψ,

\dot{ν}₂=−μF₂ sin ψ,

Values of the variables

[symbol]

\dot{φ}y sin ψ [symbol] _{ψ}, [symbol] \dot{φ}y cos ψ [symbol] _{ψ}, [symbol] \dot{φ}x sin ψ [symbol] _{ψ}, [symbol] \dot{φ}x sin ψ [symbol] _{ψ}, [symbol] cos(ψ+A sin(nψ+ψ₀))sin ψ [symbol] _{ψ}, [symbol] cos(ψ+A sin(nψ+ψ₀))cos ψ [symbol] _{ψ}, [symbol] sin ψ(ψ+A sin(nψ+ψ₀))sin ψ [symbol] _{ψ}, [symbol] sin(ψ+A sin(nψ+ψ₀))cos ψ [symbol] _{ψ} strongly depend on the parametern . Namely, right-hand sides of the equations of the averaged system are be different for different n.

For this reason, it is necessary to consider three qualitatively different cases. Case 1. n is either any integer number of the interval n>2, any fractional number of the interval 0<n<1 or any irrational one.

Averaging system above over a fast-spinning phase yr and transforming time: μτ=τ_{new}, one obtains equations in the first approximation with respect to a small parameter of the form

$${\dot{u}}_{1} = - \frac{h + {h}_{1}}{2} {u}_{1} - \frac{{h}_{1}}{2} {v}_{2} + \frac{Δ}{2} {v}_{1} + \frac{1}{2} ν {J}_{0} ( A ) , \\ {\dot{v}}_{1} = - \frac{h + {h}_{1}}{2} {v}_{1} + \frac{{h}_{1}}{2} {u}_{2} - \frac{Δ}{2} {u}_{1} , \\ {\dot{u}}_{2} = - \frac{h + {h}_{1}}{2} {u}_{2} + \frac{{h}_{1}}{2} {v}_{1} + \frac{Δ}{2} {v}_{2} , \\ {\dot{v}}_{2} = - \frac{h + {h}_{1}}{2} {v}_{2} - \frac{{h}_{1}}{2} {u}_{1} - \frac{Δ}{2} {u}_{2} - \frac{1}{2} ν {J}_{0} ( A ) .$$

Here J₀ (A) is the Bessel function of the first kind (see FIG. 7). In this case, equations are independent of a phase shift ψ₀.

Value A*=\sqrt{μ₁₀²+μ₂₀²+ν₁₀²ν₂₀²}, where μ₁₀, μ₂₀ , ν₁₀, ν₂₀ are the coordinates of the equilibrium of this linear system is the amplitude of the first harmonic. The goal is to minimize this value.

The system thus obtained has a property: in the phase space of this system there exists a stable invariant manifold M={μ₁=−ν₂, μ₂=ν₁}. Indeed, system of equations with respect to the variables μ₁+ν₂=x,ν₁−μ₂=y has the form

$$\dot{x} = - \frac{h + 2 {h}_{1}}{2} x + \frac{Δ}{2} y , \\ \dot{y} = - \frac{h + 2 {h}_{1}}{2} y - \frac{Δ}{2} x .$$

The derivative of the Lyapunov function V=x²+y², calculated in account of the system above is \dot{V}=−(h+2h₁)(x²+y²)≦0, ∀(μ₁, μ₂, ν₁, ν₂, ξ)εG. Thus, equilibrium x=0,y=0, and, therefore, integral manifold M={μ₁=−ν₂, ν₁=μ₂} is stable.

This property allows consideration of the system at the manifold M={μ₁=−ν₂=μ, μ₂=ν₁=ν} that has the form

$$\dot{u} = - \frac{h}{2} u + \frac{Δ}{2} v + \frac{ν}{2} {J}_{0} ( A ) , \\ \dot{v} = - \frac{h}{2} v - \frac{Δ}{2} u .$$

Values of the coordinates of equilibrium (μ₀,ν₀) of the system above are proportional to J₀(A). The amplitude of the first harmonic is minimal for minimal values of |J₀(A)| from the interval of allowed values of the amplitude of modulation A. The amplitude of the first harmonic is equal to zero (full damping) for all A, for which J₀(A)=0 . Bessel function J₀(A) has an infinite number of zeroes. In particular, the first zero corresponds to A=2.4 (minimal value). Having substituted A=2.4 into system above, a stable equilibrium is obtained.

Thus, having chosen A=2.4 , any integer n>2 or any irrational n, and any value of the phase shift ψ₀ (for instance, ψ₀=0), we obtain the full damping of the first harmonic of rotor bending vibration. In this case, amplitude of bending vibration becomes of the order ˜μ<<1.

Hereinafter, the following dimensionless parameters are used: h=h₁=ω=ω₀=ν=1, φ=0, μ=0.1

FIG. 8 shows x—amplitude time-history at first resonant frequency in the case of an undamped system (i.e. n=).

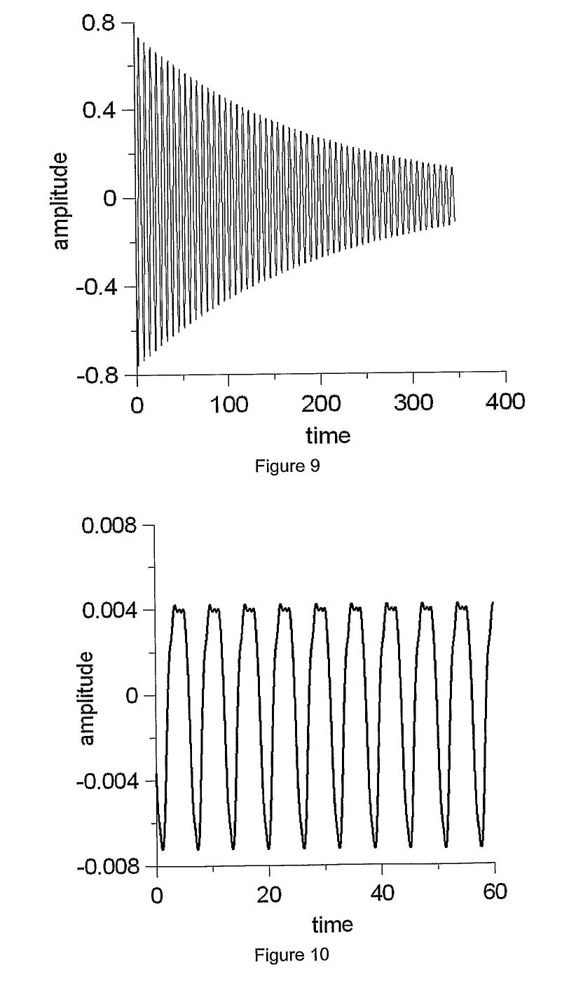

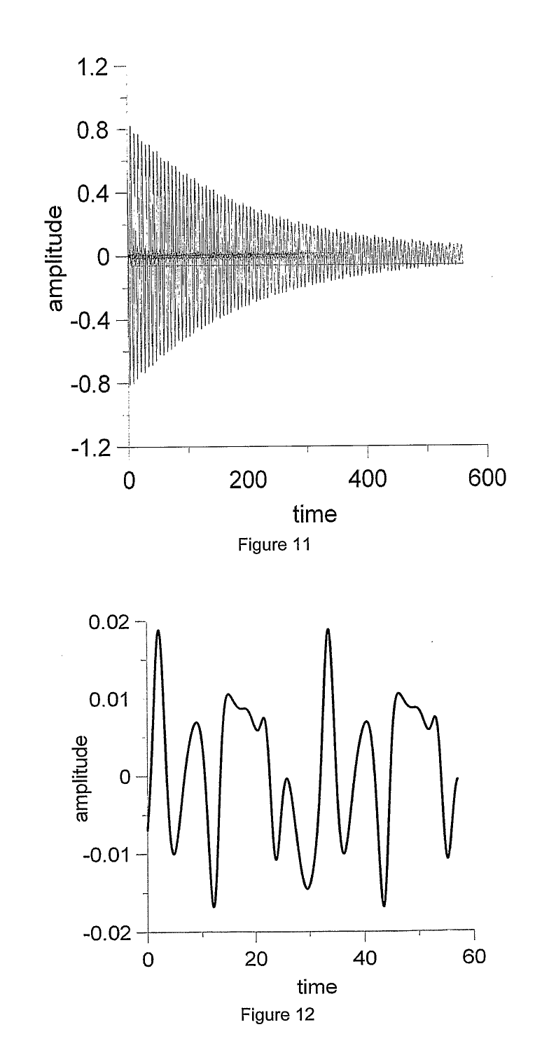

FIGS. 9-12 show transient process of damping (left figures) and damped amplitude versus time at first resonant frequency (right figures) in the case of n=3, A=2.4 and n=0.6, A=2.4 , respectively. One can see that ratio between maximal amplitudes (maximal radial displacements of the rotor from the vertical axis) in both cases compared to the undamped one is 2500 times and 50 times, respectively.

Case 2. n=1 (modulation at the rotor frequency). In this case, the averaged system takes the form

$${\dot{u}}_{1} = - \frac{h + {h}_{1}}{2} {u}_{1} - \frac{{h}_{1}}{2} {v}_{2} + \frac{Δ}{2} {v}_{1} + \frac{ν}{2} ( {J}_{0} + {J}_{2} cos 2 {ψ}_{0} )$$

$${\dot{v}}_{1} = - \frac{h + {h}_{1}}{2} {v}_{1} + \frac{{h}_{1}}{2} {u}_{2} - \frac{Δ}{2} {u}_{1} + \frac{ν}{2} {J}_{2} sin 2 {ψ}_{0}$$

$${\dot{u}}_{2} = - \frac{h + {h}_{1}}{2} {u}_{2} + \frac{{h}_{1}}{2} {v}_{1} + \frac{Δ}{2} {v}_{2} - \frac{ν}{2} {J}_{2} sin 2 {ψ}_{0}$$

$${\dot{v}}_{2} = - \frac{h + {h}_{1}}{2} {v}_{2} - \frac{{h}_{1}}{2} {u}_{1} - \frac{Δ}{2} {u}_{2} - \frac{ν}{2} ( {J}_{0} - {J}_{2} cos 2 {ψ}_{0} )$$

The equilibrium of system above is stable (the corresponding homogeneous system has a stable integral manifold with stable system, placed at this manifold, see above). This equilibrium has zero coordinates independently of the phase v₀ , if J, (A)=J₂(A)=0 . However, this system is inconsistent. In contrast to the previous case, for n=1 there are no values of A , for which the damping of the first harmonic would be full.

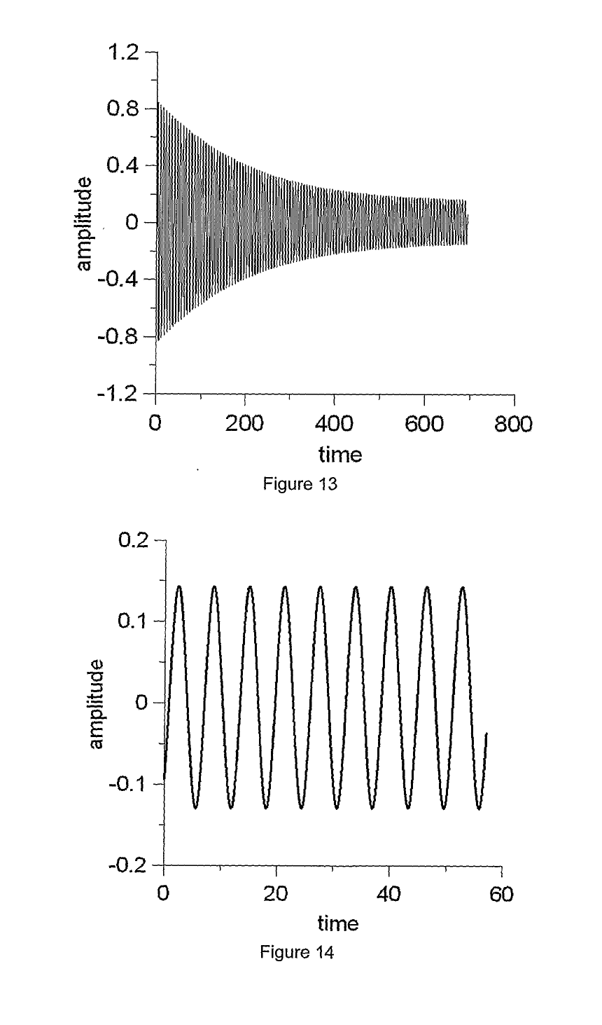

FIGS. 13 and 14 show the transient process of damping (FIG. 13) and damped amplitude versus time in at first resonant frequency (FIG. 14) in the case of n=1, A=2.4 . the ratio between maximal amplitudes in both cases compared to the undamped one is 6.67 times.

Case 3. n=2 (modulation at the doubled rotor frequency) In this case, averaged system takes the form

$${\dot{u}}_{1} = - \frac{h + {h}_{1}}{2} {u}_{1} - \frac{{h}_{1}}{2} {v}_{2} + \frac{Δ}{2} {v}_{1} - \frac{{h}_{1} A}{2} ( - {u}_{2} sin {ψ}_{0} + {v}_{2} cos {ψ}_{0} ) + \frac{ν}{2} ( {J}_{0} - {J}_{1} cos {ψ}_{0} )$$

$${\dot{v}}_{1} = - \frac{h + {h}_{1}}{2} {v}_{1} + \frac{{h}_{1}}{2} {u}_{2} - \frac{Δ}{2} {u}_{1} + \frac{{h}_{1} A}{2} ( - {u}_{2} cos {ψ}_{0} - {v}_{2} sin {ψ}_{0} ) - \frac{ν}{2} {J}_{1} sin {ψ}_{0}$$

$${\dot{u}}_{2} = - \frac{h + {h}_{1}}{2} {u}_{2} + \frac{{h}_{1}}{2} {v}_{1} + \frac{Δ}{2} {v}_{2} + \frac{{h}_{1} A}{2} ( - {u}_{1} sin {ψ}_{0} + {v}_{1} cos {ψ}_{0} ) + \frac{ν}{2} {J}_{1} sin {ψ}_{0}$$

$${\dot{v}}_{2} = - \frac{h + {h}_{1}}{2} {v}_{2} - \frac{{h}_{1}}{2} {u}_{1} - \frac{Δ}{2} {u}_{2} - \frac{{h}_{1} A}{2} ( - {u}_{1} cos {ψ}_{0} - {v}_{1} sin {ψ}_{0} ) - \frac{ν}{2} ( {J}_{0} + {J}_{1} cos {ψ}_{0} )$$

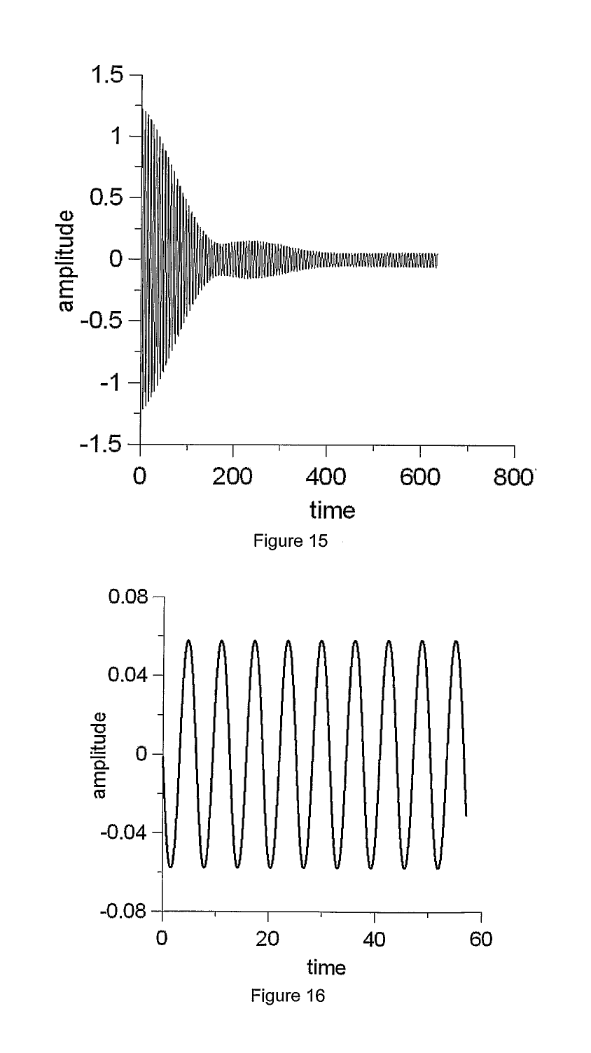

FIGS. 15 and 16 show the transient process of damping (FIG. 15) and damped amplitude versus time in at first resonant frequency (FIG. 16) in the case of n=2, A=2.7 . The ratio between maximal amplitudes in both cases compared to the undamped one is 16.67 times.

Note that in the case of integer n=1, 2 , damped vibrations are quasi-harmonic, while in the case of fractional n and n=3, damped vibrations are periodic but not harmonic.

Further variations within the scope of the invention will be apparent.

1. An oil filter for use in an electric motor forming part of a downhole device, comprising a two-part filter including a first part formed from a porous material which acts to filter solid particulate material from the motor oil and a second part comprising a sorbent for removing aqueous liquids from the motor oil.

2. An oil filter as claimed in claim 1, comprising a filter body defining a central bore through which a drive shaft of the motor can extend.

3. A oil filter as claimed in claim 2, wherein the body comprises multiple filter blocks joined together so as to define the central bore.

4. An oil filter as claimed in claim 2 wherein the body comprises a chamber formed from the porous material defining the first part of the filter, the sorbent being contained in the chamber.

5. An oil filter as claimed in claim 4, wherein the chamber comprises a U-shaped section with an angled cover.

6. An oil filter as claimed in claim 5, the porous material forming the U-shaped section has a smaller pore size than that forming the angled cover.

7. An oil filter as claimed in claim 1, wherein the porous material comprises porous metal.

8. An oil filter as claimed in claim 1, wherein the sorbent comprises silica gel, activated carbon, whitening clay, zeolite, alumina oxide or mixtures thereof.

9. A motor for a downhole device comprising a motor housing containing a stator fixed to the housing, a rotor mounted on a drive shaft in the housing, and an oil filter as claimed in any preceding claim mounted in the housing.

10. A motor as claimed in claim 9 comprising multiple filters mounted in the housing.

11. A motor as claimed in claim 10, comprising oil filters above and below the rotor and stator.

12. A motor as claimed in claim 9, further comprising a washer located around the drive shaft above the oil filter that extends radially outwardly from the drive shaft so that flow is directed through the filter rather than between the drive shaft and the filter.

13. An electric submersible pump comprising a motor as claimed in any of claim 9, wherein the drive shaft is connected to a shaft in a pump section.

14. A pump as claimed in claim 13, wherein the motor is positioned below the pump section.

15. A pump as claimed in claim 13, wherein a protector section is positioned between the motor and the pump section.

16. An electric submersible pump comprising a motor as claimed in claim 9, wherein the drive shaft is connected to a shaft in a pump section.

17. An electric submersible pump comprising a motor as claimed in claim 7, wherein the drive shaft is connected to a shaft in a pump section.

18. A pump as claimed in claim 14, wherein the protector section is positioned between the motor and the pump section.

19. An oil filter as claimed in claim 3, wherein the body comprises a chamber formed from the porous material defining the first part of the filter, the sorbent being contained in the chamber.

20. A motor as claimed in claim 10, further comprising a washer located around the drive shaft above the oil filter that extends radially outwardly from the drive shaft so that flow is directed through the filter rather than between the drive shaft and the filter.
